(19) United States
(12) Patent Application Publication
(10) Pub. No.: US 2017/0244497 A1
(43) Pub. Date: Aug. 24, 2017

(54) DETECTION OF OSCILLATIONS IN SIGNAL AMPLIFIERS

(71) Applicant: Solid RF Communication, Co. Ltd., Guangdong (CN)

(72) Inventors: Yibing GUO, Guangdong (CN); Ning ZHANG, Alberta (CA)

(73) Assignee: Solid RF Communication, Co., Ltd., Guangdong (CN)

(21) Appl. No.: 14/888,917

(22) PCT Filed: Oct. 16, 2015
(86) PCT No.: PCT/CN2015/092082

§ 371 Date: Nov. 3, 2015

(51) Int. Cl. H04B 15/00

(52) U.S. Cl. CPC H04B 15/00; H04W 84/042

(57) ABSTRACT

Systems and methods of detecting oscillation for a wireless signal amplifier are presented. The wireless signal amplifier includes an oscillation detection module configured to generate a first waveform along a frequency domain based on a first signal that has been amplified at a first gain. The oscillation detection module is configured to generate a second waveform along the frequency domain based on a second signal that has been amplified at a different, second gain. The oscillation detection module then computes a difference between the two waveforms and configures the wireless signal amplifier to modify the gain as a function of the difference.

### FIELD OF THE INVENTION

The field of the invention is signal amplification technology.

### BACKGROUND

The following description includes information that may be useful in understanding the present invention. It is not an admission that any of the information provided herein is prior art or relevant to the presently claimed invention, or that any publication specifically or implicitly referenced is prior art.

Signal amplifiers, as known as signal boosters, (e.g., cellular network amplifiers) have gained popularity in recent years as more people are relying exclusively on cellular phones in lieu of their traditional landline phone options. These signal amplifiers allow people to have strong signals even in areas (e.g., indoor areas, remote areas) that traditionally have accessibility issues due to not having a clear line of sight with base stations (as known as cellular towers).

However, signal amplifiers, if installed improperly, can generate oscillations (feedback or echo) that are disruptive to the cellular network, as they created interference with other cellular signals in the environment, for example, when the donor and server antennas are physically located too close with each other. Oscillations, if not attenuated or eliminated, would disrupt other signals in the wireless system or even render the amplifier unusable. Existing technologies detect oscillation by determining whether an oscillation or feedback is continuously growing in amplitude (or power).

Efforts have been made to detect and reduce these oscillations. For example, U.S. Pat. No. 7,409,186 titled “Detection and Elimination of Oscillation within Cellular Network Amplifiers” to Buren et al. discloses a system and method for detecting and reducing oscillations in a signal amplifier by simply detecting whether a measured signal level of a sample signal exceeds a predetermined value. However, the simplistic system discloses in Buren is inefficient and only capable of providing a coarse estimation of oscillations.

Other attempts in detecting and reducing oscillations and feedback include U.S. Pat. No. 8,583,033 titled “Oscillation Protected Amplifier with Base Station Overload and Noise Floor Protection” issued to Ashworth et al. and U.S. Pat. No. 8,874,030 titled “Oscillation Detection and Oscillation Mitigation in Amplifiers” issued to Buren et al.

However, these technologies also fail to detect oscillations when the feedback remains substantially the same amplitude. Thus, there is a need to have an improved signal booster that is capable of detecting and reducing both strong and weak oscillations caused by improper installation of a signal amplifier.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which oscillations generated by a wireless signal amplifier can be detected, and preferably reduced and eliminated. The wireless signal amplifier is configured to amplify signals within at least one frequency band (e.g., a frequency band associated with a cellular network, etc.). In some embodiments, the wireless signal amplifier detects occurrences of oscillations by comparing characteristics along a frequency domain between two signals that have been amplified at two different gains by the wireless signal amplifier. Specifically, the wireless signal amplifier generates a first waveform based on a first signal that has been amplified at a first gain, generates a second waveform based on a second signal that has been amplified at a second gain, compute a difference between the first and second waveforms, and determine whether oscillations exist within the frequency band based on the difference. If weak oscillation is detected on the signals within the narrow frequency range, the amplifier is configured to modify a gain characteristic to the signals in that narrow frequency range.

In order to generate a waveform in the frequency domain from a signal within the frequency band, the wireless signal amplifier of some embodiments divide the frequency band into multiple distinct narrow frequency ranges. The wireless signal amplifier then extracts multiple sub-signals from the signal according to the multiple distinct narrow frequency ranges, and detects the amplitude for each of the multiple sub-signals. Using the amplitudes of the multiple sub-signals, the wireless signal amplifier of some embodiments then generates a waveform along a frequency domain for the signal.

In some embodiments, the method includes the step of generating a first waveform along a frequency domain based on a first signal that has been amplified at a first gain. The method includes the step of generating a second waveform along the frequency domain based on a second signal that has been amplified at a different second gain. The method includes the step of computing a difference between the first and second waveforms, and the step of configuring the wireless signal amplifier to modify the gain as a function of the difference.

In some embodiments, the first signal is within the operational frequency band of the wireless signal amplifier. In some embodiments, the method also includes the step of dividing the frequency band into multiple distinct narrow frequency ranges. Each distinct narrow frequency range has a predetermined width. The method also includes the step of dividing the first signal into a first plurality of sub-signals according to the multiple distinct narrow frequency ranges.

In some embodiments, the method also includes the step of determining an amplitude for each of the first plurality of sub-signals, and the step of generating the first waveform based on the determined amplitudes. Preferably, the narrow frequency range has a width of less than 2.4 MHz. Even more preferably, the narrow frequency range has a width of more than 100 kHz.

Each of the first and second waveforms has a peak amplitude and a trough amplitude, wherein computing the difference comprises the steps of (a) computing a peak difference between the peak amplitudes of the first and second plurality of data points and (b) computing a trough difference between the trough amplitudes of the first and second plurality of data points.

In some embodiments, the method also includes the step of first and second waveforms has a peak amplitude and a trough amplitude, wherein computing the difference comprises (a) computing a peak difference between the peak amplitudes of the first and second plurality of data points and (b) computing a trough difference between the trough amplitudes of the first and second plurality of data points.

In some embodiments, the method also includes the step of configuring the signal booster to reduce the gain when the trough difference indicates an increase in amplitude between the trough amplitude in the first waveform and the trough amplitude in the second waveform.

In some embodiments, the method also includes the step of configuring the signal booster to abort increasing a power to incoming signals when the trough difference indicates an increase in amplitude between the trough amplitude in the first waveform and the trough amplitude in the second waveform.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an exemplary cellular network in which a wireless signal amplifier of some embodiments can operate.

FIG. 2 illustrates a wireless signal amplifier of some embodiments.

FIG. 3 illustrates an oscillation detection module of some embodiments.

FIGS. 4A and 4B illustrate an exemplary signal conversion operation performed for detecting oscillations.

FIG. 5 illustrates an example signal in a frequency domain.

FIG. 6 illustrates differences between two signals in a frequency domain.

FIG. 7 illustrates another example differences between two signals in a frequency domain.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

A wireless signal amplifier is a device that is configured to amplify (e.g., increase the power of) wireless signals. The wireless signal amplifier includes at least two antennas—the wireless signal amplifier uses one antenna to receive an inbound wireless signal, amplifies the incoming signal to generate an outbound signal, and uses the other antenna to transmit the boosted signal. Usually, each wireless signal amplifier amplifies signals within a specific range of frequencies. In the scenario where the wireless signal amplifier is configured to work with a cellular network, the amplifier can specify which one or more frequency bands (e.g., Band XII, Band XIII, etc.) that are associated with one or more cellular network (e.g., AT&T, Verizon, etc.).

The inventive subject matter provides apparatus, systems and methods in which oscillations generated by a wireless signal amplifier can be detected, and preferably reduced and eliminated. The wireless signal amplifier is configured to amplify signals within at least one frequency band (e.g., a frequency band associated with a cellular network, etc.). In some embodiments, the wireless signal amplifier detects occurrences of oscillations by comparing characteristics along a frequency domain between two signals that have been amplified at two different gains by the wireless signal amplifier. Specifically, the wireless signal amplifier generates a first waveform based on a first signal that has been amplified at a first gain, generates a second waveform based on a second signal that has been amplified at a second gain, compute a difference between the first and second waveforms, and determine whether oscillations exist within the frequency band based on the difference. If weak oscillation is detected on the signals within the narrow frequency range, the amplifier is configured to modify a gain characteristic to the signals in that narrow frequency range.

In order to generate a waveform in the frequency domain from a signal within the frequency band, the wireless signal amplifier of some embodiments divide the frequency band into multiple distinct narrow frequency ranges. The wireless signal amplifier then extracts multiple sub-signals from the signal according to the multiple distinct narrow frequency ranges, and detects the amplitude for each of the multiple sub-signals. Using the amplitudes of the multiple sub-signals, the wireless signal amplifier of some embodiments then generates a waveform along a frequency domain for the signal.

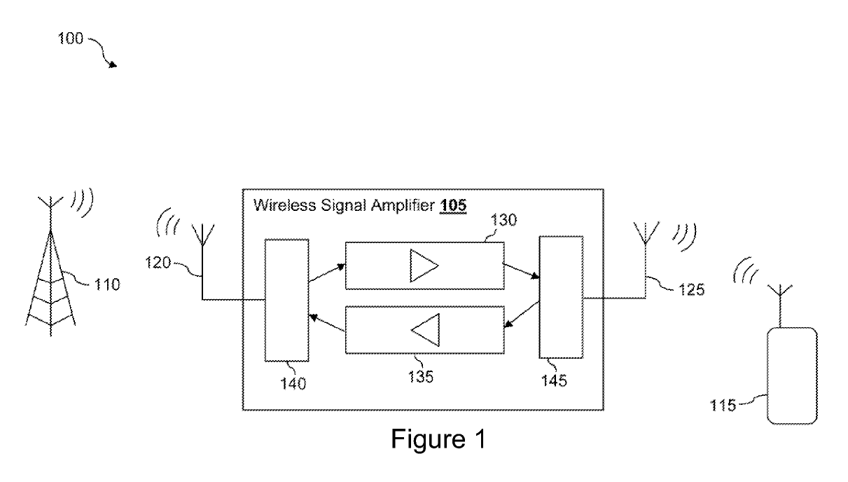

FIG. 1 illustrates an exemplary wireless communication system 100 in which a wireless signal amplifier of some embodiments can operate. The wireless communication system 100 includes a wireless signal amplifier 105, a base station 110, and a mobile device 115 (e.g., a cellular phone, a tablet, etc.). The wireless signal amplifier 105 amplifies signals transmitted between the base station 110 and the mobile device 115. The wireless signal amplifier 105 has two antennas: a donor antenna 120 and a server antenna 125, a duplexer 140, a duplexer 145, a downlink amplification path 130, and an uplink amplification path 135. In a downlink direction, the wireless signal amplifier 105 receives downlink signals transmitted by the base station 110 via the donor antenna 120, amplifies the downlink signals via the downlink amplification path 130, and transmitted the amplified downlink signals to the mobile device 115 via the server antenna 125. Similarly in an uplink direction, the wireless signal amplifier 105 receives uplink signals transmitted by the mobile device 115 via the server antenna 125, amplifies the uplink signals via the uplink amplification path 135, and transmitted the amplified uplink signals to the base station 110 via the donor antenna 120.

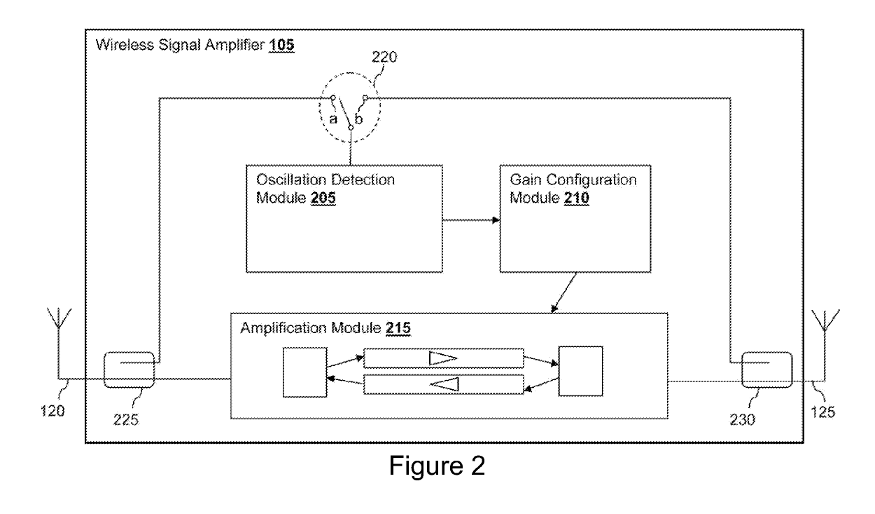

FIG. 2 illustrates the wireless signal amplifier 105 in more detail. Specifically, FIG. 2 illustrates at least some of the components that enable the wireless signal amplifier 105 to detect and reduce (and preferably eliminate) oscillations. As shown, in addition to the donor antenna 120 and the server antenna 125, the wireless signal amplifier 105 has an oscillation detection module 205, a gain configuration module 210, a switch 220, couplers 225 and 230, and an amplification module 215. In some embodiments, the amplification module 215 can include one or more amplification paths for amplifying signals. For example, the amplification module 215 can include duplexers, a downlink amplification path, and an uplink amplification path as shown in FIG. 1. The couplers 225 and 230 couples the donor antenna 120 and the server antenna 125 to the switch 220 that connects to the oscillation detection module 205.

As shown, the switch 220 has two positions—position ‘a’ and position ‘b.’ When the switch 220 is at position ‘a,’ the oscillation detection module 205 can retrieve a signal from the coupler 225 (e.g., an uplink signal to be transmitted via the donor antenna 120). When the switch 220 is at position ‘b,’ the oscillation detection module 205 can retrieve a signal from the coupler 230 (e.g., a downlink signal to be transmitted via the donor antenna 125).

The wireless signal amplifier 105 is configured to amplify signals within one or more frequency band. For purposes of illustrations, the wireless signal amplifier 105 in this example is configured to amplify signals within the operating band of Band XII, which has an uplink frequency range from 698 MHz to 716 MHz and a downlink frequency range from 728 MHz to 746 MHz. A person who is skilled in the art can appreciate that the wireless signal amplifier 105 can operate on signals in other bands in place of or in addition to Band XII.

The oscillation detection module 205 uses the switch 220 and the couplers 225 and 230 to alternately scan for signals at or near the donor antenna 120 and server antenna 125 one at a time. In some embodiments, the oscillation detection module 205 scans for only the output signals before the signals are transmitted via the donor antenna 120 or the server antenna 125. Output signals are signals that have been processed by the amplification module 215 before they are transmitted to the base station or to the mobile device. The output signals are preferred because they generally have higher amplitude than signals before they are processed by the amplification module 215.

As mentioned before, oscillation detection module 205 uses the switch 220 to alternately scans for signals from the coupler 225 (signals to be transmitted to a base station via the donor antenna 120) and signals from the coupler 230 (signals to be transmitted to a mobile device via the server antenna 230). In this example, the oscillation detection module 205 first scans an uplink signal from the coupler 225 by turning to switch to position ‘a.’ The oscillation detection module 205 generates a waveform along a frequency domain for the uplink signal.

In order to generate the waveform along the frequency domain, the oscillation detection module 205 determines multiple amplitudes of the signal (that spans across the frequency band spectrum) at multiple frequencies (or multiple narrow frequency ranges). Thus, in some embodiments, the oscillation detection module 205 first divides the signal into multiple sub-signals, each sub-signal corresponds to a different frequency (or narrow frequency range) within the frequency band. It is appreciated that the more sub-signals that the oscillation detection module 205 divides the signal, and thus the more amplitude data at different frequency points the oscillation detection module 205 can generate, the better resolution of the waveform the oscillation detection module 205 can generate. On the other hand, dividing the signal into more sub-signals and generate more amplitude data also requires larger amount of time.

Upon determining the multiple amplitudes at different frequencies (or different frequency ranges) for the signal, the oscillation detection module 205 generates a waveform along the frequency domain, by methods such as regression.

The oscillation detection module 205 then reduces a gain of the wireless signal amplifier 105 by a predetermined reduction amount via the gain configuration module 210. Preferably the reduction amount is less than 3 decibel (dB). Even more preferably the reduction amount is less than 2 dB. After the gain of the wireless signal amplifier 105 is reduced by the reduction amount, the oscillation detection module 205 retrieves another signal from the coupler 225, and generates a waveform for this signal using the method described above. The oscillation detection module then compares the waveforms generated for the two signals that have been amplified at two different gains—the first signal amplified at the regular gain of the amplifier 105 and the second signal amplified at the reduced gain, and computes a difference between the two waveforms. Based on the difference between the two waveforms, the oscillation detection module 205 works with the gain configuration module 210 to modify the gain characteristic (e.g., the gain) of the wireless signal amplifier 105.

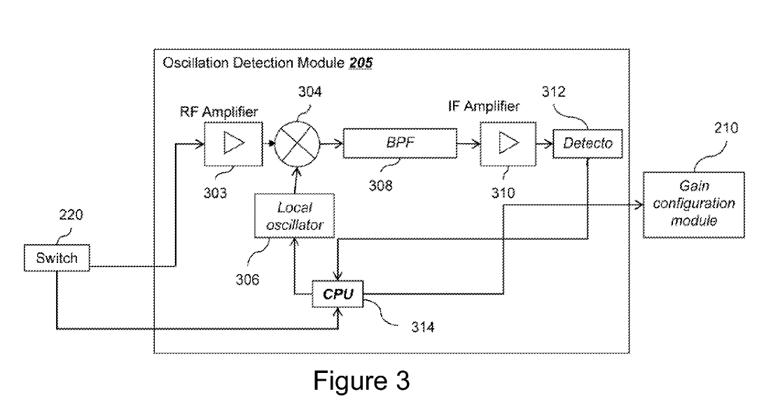

For example, the oscillation detection module 205 can compare one or more peak amplitudes between the two waveform and one or more trough amplitudes between the two waveforms to determine whether oscillations have occurred. If it is determined that there is no oscillation, the oscillation detection module 205 will not modify the gain of the amplifier 105. On the other hand, if it is determined that oscillations have occurred, the oscillation detection module 205 can modifies, such as reducing the gain of the amplifier 105 by an amount (e.g., by more than 3 dB, by more than 5 dB, by more than 10 dB, etc.), or in some embodiments, eliminating any gain to the signals within the frequency band. How the oscillation detection module 205 generates the waveforms and computes the difference between the waveforms will be described in more detail below by reference to FIG. 3.

The oscillation detection module 205 can be implemented in different ways. FIG. 3 illustrates an example oscillation detection module that is implemented as a circuit 300. The oscillation detection module 205 includes a radio frequency amplifier 303, a mixer 304, a local oscillator 306, a band-pass filter 308, an intermediate frequency amplifier 310, a detector 312, and a central processing unit (CPU) 314. The CPU 314 includes a processor and a memory. The memory of the CPU 314 stores, in part, software instructions that when executed perform a set of functions for the oscillation detection module 205 as described below.

The radio frequency amplifier 303 of the oscillation detection module 205 receives a signal (referred to as an “initial signal”) from either the donor antenna 120 or the server antenna 125 via the selector switch 220. As mentioned above, the signal in some embodiments is an output signal of the wireless signal amplifier 105 (although an input signal can be used, it is less preferable). As such, the initial signal is within the frequency band (referred to as “operating frequency band”) in which the amplifier 105 is configured to amply signals.

The radio frequency amplifier 303 amplifies the initial signal to compensate losses from the coupler (coupler 225 or 230) and the switch 220. Then, the CPU 314 stores the initial signal in its memory, sends the signal to the mixer 304, and configures the local oscillator 306 to provide an output signal to the mixer 304. The mixer 304 combines the initial signal with the output from the local oscillator 306 to convert the initial signal from the operating frequency band into an intermediate frequency (IF) band (ignoring that an additional heterodyne is also produced, since only the IF band is necessary for the oscillation detection module 205). Next, the band-pass filter 308 is configured to allow only a portion of initial the signal (referred to as a “sub-signal” or a “filtered signal”) within a desired narrow frequency range of the IF band to pass to an intermediate frequency amplifier 310. By doing so, a portion of the initial signal within a specific narrow frequency range from the operating frequency band is extracted. It is noted that by configuring the local oscillator 306 to provide different output signals (e.g., in the form of a frequency) to the mixer 304, the mixer will convert the initial signal from the operating frequency band into different IF bands.

The intermediate frequency amplifier 310 amplifies the filtered signal it receives from the band-pass filter 308 to allow the detector 312 to more accurately detect the amplitude of the filtered signal. The detector 312 then sends the amplitude information to the CPU 314, which stores the amplitude information in its memory. It is appreciated that through this process, the CPU 314 is able to obtain the amplitude information of a portion of the initial signal within the specific narrow frequency range. The CPU 314 then performs the process described above on the same initial signal stored in the memory, except by configuring the local oscillator 306 to provide a different output signal to the mixer 304 such that, along with the band-pass filter 308, a different portion of the initial signal (a different sub-signal or a different filtered signal) within a different narrow frequency range from the frequency band is extracted. The CPU 314 will repeat the above process to extract different portions of the initial signal until all portions of the initial signal are extracted and amplitude information of those portions of the initial signal are obtained by the CPU 314.

The CPU 314 then uses the detected amplitudes to plot a graph in the frequency domain. In some embodiments, the CPU 314 also generates a curve based on the amplitude information, for example, by performing regression on the amplitude information of the different sub-signals.

The CPU 314 instructs the gain configuration module 210 to modify the gain that the wireless signal amplifier 105 applies to signals within the frequency band. In some embodiments, the CPU 314 instructs the gain configuration module 210 to reduce the gain by a small reduction amount (e.g., 2 dB, 1 dB, etc.). The CPU 314 then retrieves another signal (referred to as a “test signal”) from the same antenna (from which the initial signal was retrieved) via the switch 220. The CPU 314 performs the same process, as described above for the initial signal, to the test signal to obtain another curve. The CPU 314 then detects whether oscillation exists by analyzing the two curves (the curve generated based on the initial signal and another curve generated based on the test signal).

The oscillation detection process is illustrated in more detail by way of an example. In this example, the wireless signal amplifier 105 is configured to amplify signal in Band XII, which has an uplink frequency range from 698 MHz to 716 MHz and a downlink frequency range from 728 MHz to 746 MHz. It is appreciate that instead of, or in addition to, Band XII, the amplifier 105 can be configured to amplify signals within other frequency bands. Possible frequency bands include: a cellular frequency band, a WiFi frequency band, or a Bluetooth frequency band. Cellular frequency bands can include the Lower 700 Mhz band (698-716 MHz and 724-746 MHz),the Upper 700 Mhz band (776-787 MHz and 746-757 MHz), the Cellular band (824-849 MHz and 869-894 MHz), the PCS band (1,850-1,915 MHz and 1,930-1,995 MHz), the AWS band (1,710-1,755 MHz and 2,110-2,155 MHz), and the BRS/EBS band (2,496-2,690 MHz).

The CPU 314 of the oscillation detection module 205 uses the switch 220 to scan, in rotation, outputs of every uplink and downlink frequency band that the wireless signal amplifier is operating on. First, the CPU 314 instructs the switch 220 to move to position ‘a’ to retrieve an output signal from the coupler 225 (the signal is an uplink signal in the frequency range from 698 MHz to 716 MHz). The retrieved signal is referred to as the initial signal.

The CPU 314 then works with the mixer 304, the local oscillator 306, and the band-pass filter 308 to extract a portion of the initial signal (i.e., a sub-signal) within a narrow frequency range from the frequency band. Preferably, the narrow frequency range has an upper limit in width of 2.4 MHz. Even more preferably, the narrow frequency range has a lower limit in width of 100 kHz. For example, during the first iteration, the CPU 314 extracts a sub-signal within the frequency range of 698-702 MHz in the first pass. To do this, the CPU 314 configure the local oscillator 306 to provide a certain output to cause the mixer 304 to convert the initial signal from the frequency band to an IF band, such that the band-pass filter 308 would filter out all the portions of the signal in frequencies other than the narrow frequency range.

In electronics, a local oscillator is an electronic oscillator used with a mixer to change the frequency of a signal, and a mixer or frequency mixer is a nonlinear electrical circuit that creates new frequencies (heterodynes) from two signals applied to it. Using an output from the local oscillator 306 and the signal from the selector switch 302, the mixer 304 converts the signal from the selector switch 302 into, among other heterodynes, an IF band.

The IF band signal is then passed through the band-pass 308 filter. Ideally, the band-pass filter 308 in the oscillation detection module 205 has a static range (e.g., 68 MHz-72 MHz). Preferably the static range has the same width as the narrow frequency range that the CPU 314 desires. The band-pass filter 308 allows only a portion of the IF band signal to pass through to the intermediate frequency amplifier 310. In order to obtain the portion of the initial signal within the frequency range of 698-702 MHz, the CPU has to configure the local oscillator 306 to provide an output to the mixer 304 such that the mixer 304 converts the initial signal from the frequency band to an IF band of 68-86 MHz. When the initial signal (now in the frequency range of 68-86 MHz) enters into the band-pass filter 308, only the portion of the initial signal within the frequency range of 68-72 MHz (which corresponds to the signal within the frequency range of 698-702 MHz prior to the conversion) will pass through.

After leaving the band-pass filter 308, the intermediate frequency amplifier 310 compensates for losses resulting from the signal's passage through the mixer 304 and the band-pass filter 308 by amplifying the portion of the signal. The intermediate frequency amplifier 310 can be any amplifier known in the art that is capable of the necessary amplification. In particular, it is sometimes advantageous to implement an intermediate frequency amplifier 310 that amplifies only signals falling within the frequency range of the band-pass filter 308. It is also sometimes advantageous to implement an amplifier that does not target any particular frequency range.

After amplification, the filtered and amplified signal passes to the detector 312, which detects one or more amplitudes of the filtered and amplified signal. Each detected amplitude corresponds to an amplitude of the original signal at a particular frequency. The detector 312 passes detected amplitude information to the CPU 314, and each amplitude information is stored along with its associated frequency or frequency range (e.g., to create a frequency domain graph).

In some embodiments, the radio frequency amplifier 303 receives another initial signal from the switch 220. The CPU 314 then configures the local oscillator to provide a different output to the mixer, such that the mixer 304 converts the initial signal from the frequency band to a different IF band. In this example, the CPU 314 wants to detect the amplitude of the portion of the signal corresponds to the narrow frequency range of 702-706 MHz. As such, the CPU 314 configures the local oscillator 306 to provide an output such that the mixer 304 converts the initial signal from the frequency band to an IF band of 64-82 MHz. When the converted signal passes through the band-pass filter 308, only the portion of the signals within the frequency range of 68-72 MHz (which corresponds to the portion of the initial signal within the frequency range of 702-706 MHz before the conversion). The detector 312 detects one or more amplitudes and sends the amplitude information to the CPU 314. Again, the CPU 314 stores the amplitude information along with its associated frequency or frequency range.

Once enough samples (different portions of the initial signal) are taken (e.g., once enough IF band signals have been passed through the band-pass filter, amplified, detected, and sent to the CPU 314), a curve fit (e.g., a linear regression, or a curve fit) can be used to develop a frequency domain curve. Preferably, all portions of the initial signal have to go through the detection process to make an accurate curve. In some embodiments, the curve appears in a waveform.

The CPU 314 then uses the gain configuration module 210 to reduce the gain that the amplifier 105 applies to signals within the frequency band by a small reduction amount (e.g., by 0.5-1.5 dB, 1-2 dB, 1.5-2.5 dB, or 2-3 dB, etc.). The CPU 314 then retrieves another signal (referred to as a “test signal”) from the donor antenna 120 (same antenna from which the initial signal is retrieved) by using the switch 220. The CPU 314 of some embodiments performs the same process as described above to generate a frequency domain curve (or waveform) for the test signal. In some embodiments, the CPU 314 detects occurrences of oscillations based on an analysis of the two waveforms (e.g., a comparison of the two). For example, the CPU 314 of some embodiments determines whether oscillations exist within the frequency band based on a difference between the two waveforms.

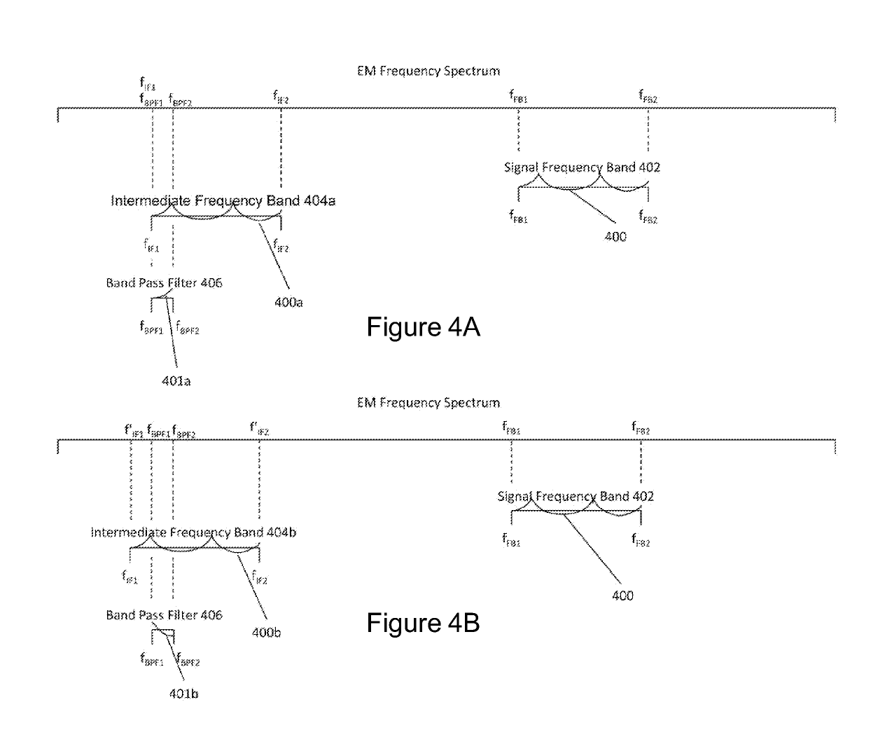

FIGS. 4A and 4B illustrates the process of detecting amplitudes corresponding to different frequency ranges for a signal, in a graphical representation. As shown in FIG. 4A, the signal 400 coming from the selector switch 220 into the oscillation detection module 205 of the wireless signal booster exists within a particular frequency band that ranges from f_{FB1} to f_{FB2}, where f_{FB2}−f_{FB1}=Δf_{FB}. The mixer 304 in the oscillation detection module 205 works in tandem with the local oscillator 306 to convert the signal 400 from the signal frequency band 402 into a first IF band 404a (ignoring any other heterodynes that may be output by the mixer), resulting in a first IF band signal 400a. The first IF band 404a ranges from f_{IF1} to f_{IF2}, where f_{IF2}−f_{IF1}=Δf_{IF} and Δf_{IF}≈Δf_{FB}. The first IF band signal 400a is then passed through the band-pass filter 406, which has a bandwidth ranging from f_{BPF1} to f_{BPF2}, where f_{BPF2}−f_{BPF1}=Δf_{BPF} and Δf_{BPF}<Δf_{IF}. Since Δf_{BPF}<Δf_{IF}, only a portion of the first IF band signal 400a is able to pass through the band-pass filter 406, resulting in a filtered 401a that can be amplified and measured in preparation of creating a frequency domain graph corresponding to the signal 400 (e.g., by plotting on a frequency domain graph an amplitude associated with filtered signal 401a) as described above by reference to FIG. 3.

FIG. 4A, however, shows only a first iteration that the oscillation detection module 205 must go through to determine whether weak oscillation exists. FIG. 4B shows a second iteration. The signal 400 in FIG. 4B is the same as signal 400 shown in FIG. 4A. The mixer 304 in the oscillation detection module 205 again works in tandem with the local oscillator 306 to convert the signal 400 from the signal frequency band 402 into a second IF band 404b, resulting in an second IF band signal 400b. The second IF band 404b ranges from f_{IF1} to f_{IF2}. AS shown, the second IF band 404b is different from the first IF band 404a, so that when passing through the same band pass filter 406, a different portion of the signal 400b would pass through. The second IF band signal 400b is then passed through the band-pass filter 406, which has a bandwidth ranging from f_{BPF1} to f_{BPF2}, where f_{BPF2}−f_{BPF1}−Δf_{BPF} and Δf_{BPF}<Δf_{IF}. Since Δf_{BPF}<Δf_{IF}, only a portion of the second IF band signal 400b is able to pass through the band-pass filter 406, resulting in a filtered signal 401b that can be amplified and measured to continue creating a frequency domain graph corresponding to the signal 400. Although filtered signal 401b exists within the same frequency range as filtered signal 401a, both filtered signals correspond to different portions of signal 400 by virtue of the different IF frequency bands that produced each filtered signal. This process is repeated until the entirety of the signal 400 has been broken down into signal blocks that have been passed through the band-pass filter and subsequently amplified, measured, and recorded to create a complete frequency domain graph corresponding to that signal 400.

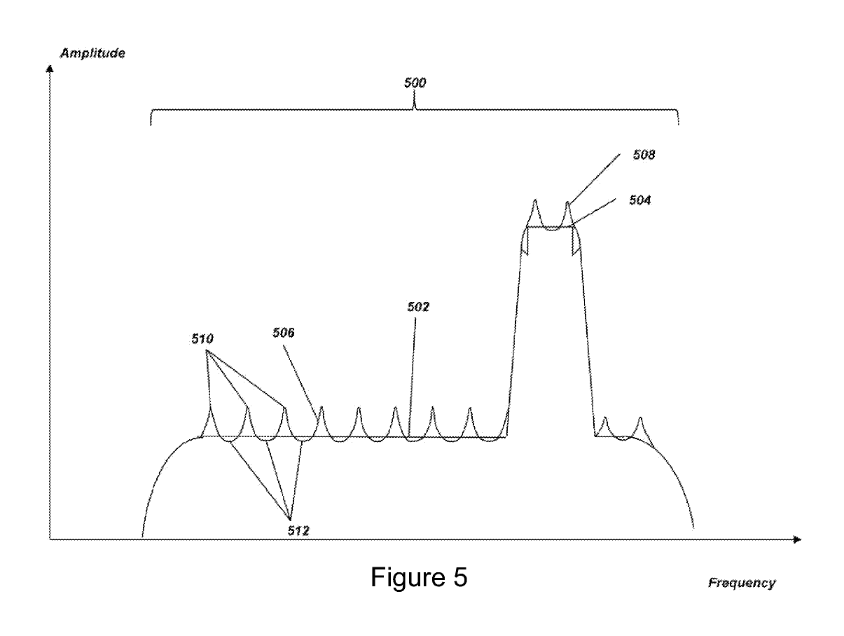

FIG. 5 shows data contained in a frequency band 500 as represented by the CPU upon going through the processes described in detail above with respect to FIG. 3 and FIGS. 4A and 4B (e.g., plotting amplitudes in a frequency domain before performing, for example, a curve fit). FIG. 5 shows a normal noise base 502 and a normal signal 504 each spanning horizontally across a range of frequencies. Because FIG. 5 is graphed in the frequency domain (e.g., the x-axis corresponds to frequency and not time), the amplitudes of waveforms across a range of frequencies are all be represented simultaneously. Here, since the normal noise base 502 and normal signal 504 are both horizontal on the graph, that means the waveforms associated with each have similar amplitudes.

In the presence of oscillation, the normal noise base 502 becomes line 506 having peaks 510 and troughs 512 that occur at different frequencies. These peaks 510 and troughs 512 are the result of constructive (in phase) and destructive (out of phase) interference of waveforms that are picked up by the receiving antenna from the broadcasting antenna when insufficient isolation exists between the two. Isolation is a function of, among other factors, the distance and amount of interfering material that exists between the two antennas of the wireless signal booster, and the gain applied to a rebroadcast signal can affect how much of that signal is received by the receiving antenna despite some amount of isolation. Peaks 510 occur when superposed data received in a frequency band 500 are in phase, causing constructive interference, and troughs 512 occur when superposed signals are out of phase, causing destructive interference. Detecting the presence of both types of interference is critical in determining whether weak oscillation is occurring within the system. When oscillation detection module 205 of FIG. 3 is detects oscillation, it sends a control signal to the gain configuration module 316 to adjust the wireless signal booster's gain, or in some embodiments shut down the amplification path for that frequency band.

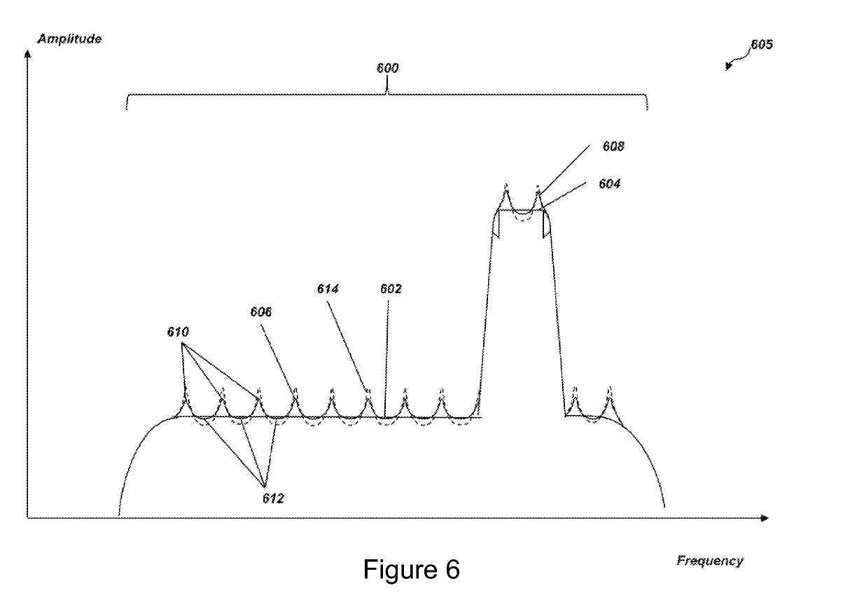

FIG. 6 shows one example of the curves (or waveforms) generated based on an initial signal and a test signal on a frequency domain graph 605. The graph 605 has two axes: a frequency domain axis (horizontal) and an amplitude axis (vertical). In this example, the dotted line 614 represents the curve (or waveform) generated based on the amplitude information corresponds to an initial signal, while solid line 606 represents the curve (or waveform) generated based on the amplitude information corresponds to a test signal. As shown, the peak amplitudes 610 are reduced while the trough amplitudes 612 are increased in the test signal, when compared to the initial signal. The same happens to the oscillations present in the desired signal 608, which also converges toward the signal 604. In some embodiments, when the CPU 314 detects this convergence (e.g., peak amplitudes going down while trough amplitudes going up), the CPU 314 determines that there is oscillations within the frequency band.

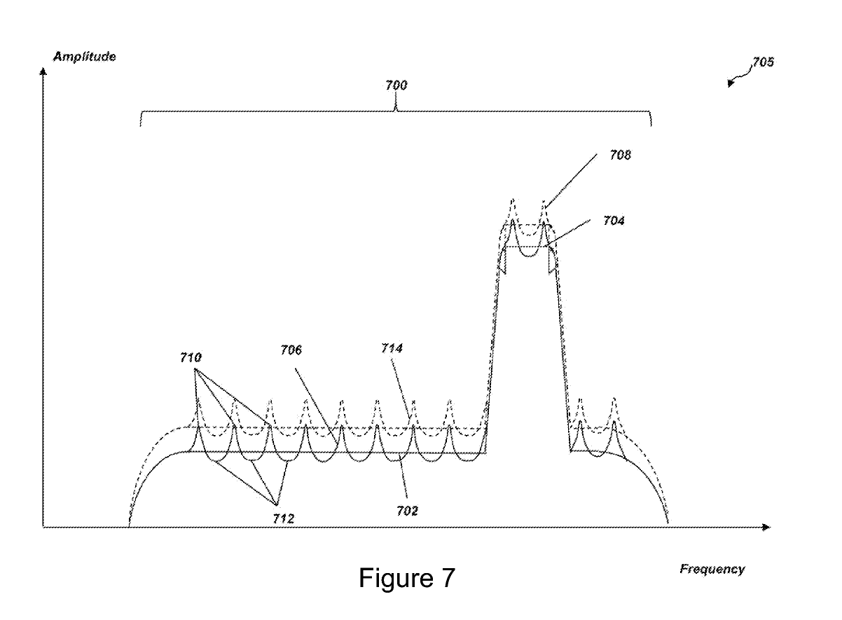

FIG. 7 illustrates another example of the curves (or waveforms) generated based on an initial signal and a test signal on a frequency domain graph 705. In this example, the entire curve (or waveform) representing the test signal has lower amplitude than that of the initial signal. Specifically, every portion of the signal 700 reduces proportionally to the amount that gain was reduced. For example, noise 714 drops down a fixed amount across the entire frequency to line 706. In this situation, since no oscillation is detected, the gain can safely be adjusted back to its original value. In some embodiments, the CPU 314 determines that no oscillation exists in the frequency band when there is no convergence (e.g., the entire curve moves down in amplitudes from the initial signal to the test signal).

In some embodiments, upon determining that the frequency band is experiencing oscillations, the CPU 314 configures the wireless signal amplifier 105 via the gain configuration module 210 to substantially reduce the gain (e.g., more than 5db, more than 10, more than 20db, etc.). In other embodiments, the CPU 314 configures the wireless signal amplifier 105 via the gain configuration module 210 to abort applying any gain to signals in the frequency band upon determining that the frequency band is experiencing oscillations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of detecting oscillation in a wireless signal amplifier configured to generate a gain in power for signals within a frequency band, the method comprising:
generating a first waveform along a frequency domain based on a first signal that has been amplified at a first gain;
generating a second waveform along the frequency domain based on a second signal that has been amplified at a different, second gain;
computing a difference between the first and second waveforms; and
configuring the wireless signal amplifier to modify the gain as a function of the difference.

2. The method of claim 1, wherein the first signal is within the frequency band.

3. The method of any one of the preceding claims, further comprising:
dividing the frequency band into multiple distinct narrow frequency ranges, wherein each distinct narrow frequency range has a predetermined width; and
dividing the first signal into a first plurality of sub-signals according to the multiple distinct narrow frequency ranges.

4. The method of any one of the preceding claims, further comprising:
determining an amplitude for each of the first plurality of sub-signals; and
generating the first waveform based on the determined amplitudes.

5. The method of any one of the preceding claims, wherein each distinct narrow frequency range has a width of less than 2.4 MHz.

6. The method of any one of the preceding claims, wherein each distinct narrow frequency range has a width of more than 100 kHz.

7. The method of any one of the preceding claims, wherein each of the first and second waveforms has a peak amplitude and a trough amplitude, wherein computing the difference comprises (a) computing a peak difference between the peak amplitudes of the first and second plurality of data points and (b) computing a trough difference between the trough amplitudes of the first and second plurality of data points.

8. The method of any one of the preceding claims, further comprising configuring the signal booster to reduce the gain when the trough difference indicates an increase in amplitude between the trough amplitude in the first waveform and the trough amplitude in the second waveform.

9. The method of any one of the preceding claims, further comprising configuring the signal booster to abort increasing a power to incoming signals when the trough difference indicates an increase in amplitude between the trough amplitude in the first waveform and the trough amplitude in the second waveform.

10. The method of any one of the preceding claims, further comprising configuring the signal booster to reduce the gain when the peak difference indicates a decrease in peak amplitude between the peak amplitude in the first waveform and the peak amplitude in the second waveform and the trough difference indicates an increase in amplitude between the trough amplitude in the first waveform and the trough amplitude in the second waveform.

11. The method of any one of the preceding claims, wherein the first and second signals are output signals retrieved immediately prior to being transmitted by the signal booster.

12. The method of any one of the preceding claims, further comprising converting the first plurality of sub-signals from the distinct narrow frequency range to an intermediate narrow frequency range.

13. The method of any one of the preceding claims, wherein the intermediate narrow frequency range is outside of the frequency band.

14. The method of any one of the preceding claims, wherein the second gain is lower than the first gain by a predetermined reduction.

15. The method of any one of the preceding claims, wherein the predetermined reduction is less than 3 dB.

16. A wireless signal amplifier, comprising:
an antenna configured to receive a first signal and a second signal;
an amplification path configured to apply different gains to the first and second signals;
an oscillation detection circuitry that is configured to (i) generate a first waveform along a frequency domain based on the first signal that has been amplified at a first gain, (ii) generate a second waveform along the frequency domain based on the second signal that has been amplified at a different, second gain, (iii) compute a difference between the first and second waveforms, and (iv) configure the amplification path to modify the gain as a function of the difference.

17. The wireless signal amplifier of claim 16, wherein the oscillation detection circuitry comprises a mixer and a local oscillation configured to collaborate with each other to convert the first signal from a first frequency band to a modified first signal within a second frequency band.

18. The wireless signal amplifier of any one of the preceding claims, wherein the oscillation detection circuitry further comprises a band-pass filter configured to convert the extract, from the modified first signal within the second frequency band, an intermediate signal within a narrow frequency range.

19. The wireless signal amplifier of any one of the preceding claims, wherein the oscillation detection circuitry further comprises a detecting circuitry configured to detect an amplitude of the intermediate signal.

20. The wireless signal amplifier of any one of the preceding claims, wherein the oscillation detection circuitry further comprises a processor configured to generate the first and second waveforms based on the detected amplitude.
